(19) United States
(12) Patent Application Publication
(10) Pub. No.: US 2017/0235438 A1
(43) Pub. Date: Aug. 17, 2017

(54) INTERACTIVE SOCIAL MEDIA AND BUSINESS PLATFORM AND METHODS THEREOF

(71) Applicant: Andrew Michael Atalla, Centreville, VA (US)

(72) Inventor: Andrew Michael Atalla, Centreville, VA (US)

(21) Appl. No.: 15/044,642

(22) Filed: Feb. 16, 2016

(51) Int. Cl. G06F 3/0482; H04L 29/08

(52) U.S. Cl. CPC G06F 3/0482; H04L 67/1097; H04L 67/306; G06Q 50/01

(57) ABSTRACT

An interactive social and business platform system including a first communication device coupled to a first processor, a first display screen, and a first storage medium, a second communication device coupled to a second processor, a second display screen, and a second storage medium, a third communication device coupled to a third processor, a third storage medium, and a third display screen, a network storage medium to store a first user profile information corresponding to the first communication device, a second user profile information corresponding to the second communication device, and a third user profile information corresponding the third communication device, the network storage medium in communication with the first, second, and third communication device through a communication network, and a network controller configured to control access to user profile information stored within the network storage medium based upon user profile information corresponding to a communication device requesting access.

### BACKGROUND

1. Field of the Invention

The present general inventive concept relates generally to a business platform, and more particularly to an interactive social media and business platform used to selectively share profile information, including work schedule information, with authorized or approved users, in real-time.

2. Description of the Related Art

Over the years, social media has helped develop and grow many businesses by allowing businesses to communicate directly with their customers. However, many customers are often attracted to these businesses based on their employees rather than the goods or services the businesses provide. Customers appreciate knowledgeable, personable, and friendly staff, and therefore prefer visiting businesses when certain employees, bartenders, or servers are on duty. With constantly changing work schedules, however, customers are required to physically go to the businesses to confirm whether or not their preferred employees are working, which is an inefficient use of time and resources.

Some customers may choose to call the businesses directly, send a text message to the employees, or use various social media applications to directly message the employees in order to determine whether their preferred employees are currently working.

However, since many businesses do not disclose employee information such as work schedules without the employee's prior consent, a business and social platform that allows secure communication between businesses, employees, and guests during work hours that may be monitored and managed by the business is highly desirable.

### BRIEF SUMMARY OF THE INVENTION

The present general inventive concept also provides a mobile application and system for facilitating an interactive social media and business platform used to connect businesses (i.e., organizations), managers of the business, employees of the business, and others involved in the business (e.g., vendors and marketing firms) with customers of the business in a regulated manner.

The present general inventive concept also provides an interactive social media and business platform which integrates and streamlines a process of a user (e.g., guest) searching for a business (e.g., a restaurant), viewing reviews of the business, making a reservation, acknowledging arrival at the business (e.g., checking in), inviting other users, taking and/or sharing photos, making a payment to the business, rating the service and product of the business, and sending or receiving gift certificates or cards. In exemplary embodiments, the servers may issue gift cards and/or certificates for discounts to desired users or guests. In alternative example embodiments, the servers may offer free or discounted appetizers, meals, drinks, or desserts to desired guests.

Features and/or utilities of the present general inventive concept provide an interactive social and business platform system including a first communication device coupled to a first processor, a first display screen, and a first storage medium, a second communication device coupled to a second processor, a second display screen, and a second storage medium, a third communication device coupled to a third processor, a third storage medium, and a third display screen, a network storage medium to store a first user profile information corresponding to the first communication device, a second user profile information corresponding to the second communication device, and a third user profile information corresponding the third communication device, the network storage medium in communication with the first, second, and third communication device through a communication network and a network controller configured to control access to user profile information stored within the network storage medium based upon user profile information corresponding to a communication device requesting access.

The first communication device may correspond to a business, the second communication device corresponds to an employee of the business, and the third communication device corresponds to a guest of the business.

The first user profile information may include business identification information, manager identification information, and a first user social network information.

The second user profile information may include second user identification information, employment history information, current work schedule information, guest rating information, guest comments information, and second user social network information.

The third user profile information may include third user identification information and third user social network information.

The third user identification information may be added to the second user social network information when the second communication device sends a request signal to authorize the third user to the network controller.

The network controller may provide access to the second user profile information if the third user identification information corresponding to the third communication device is within the second user social network information stored within the network storage medium.

The network controller may automatically update current work schedule of a second user corresponding to the second communication device when receiving an update signal from the first communication device.

The network controller may instruct the third processor to generate and display a first indicator on the third display screen when the network controller determines that the second user is currently working based on the second user profile information stored within the network storage medium.

The third user may be added to the social network information of the second user when the third communication device sends a social network request to the second communication device and is accepted by the second communication device.

The network controller may allow the first, second, and third communication devices to communicate with each other through the communication network.

The network controller may allow the first communication device to monitor communications between the second and third communication devices.

Features and/or utilities of the present general inventive concept also provide an interactive social and business platform system including a first communication device a communication device, such as a mobile device having a display screen to display an interactive menu screen to allow a first user to input and receive information, the device includes at least one processor to generate the interactive menu screen displayed on the display screen, a memory device coupled to or integrated with the at least one processor and configured to store program instructions that when instructed by the first user causes the at least one processor to display the interactive menu screen (i.e., menu screen) on the display screen, receive first user profile information corresponding to the first user, transmit the first user profile information to a network to be stored within an external database, transmit a request to retrieve second user profile information corresponding to a second user stored within the external database through the network, the second user profile information including second user employment location information and work schedule information, receive the second user profile information from the external database if the first user is stored within a second user social network of the second user stored within the external database, and display a first visual indicator on the interactive menu screen when the second user is scheduled to work on a date input by the first user and a second visual indicator when the second user is off duty on the inputted date.

The first visual indicator may be a green colored image displayed on the display screen and the second visual indicator is a red colored image displayed on the display screen. In alternative embodiments, various other visual and/or audio indicators may be used to notify third users when second users are currently working at businesses described or defined within the second users' profile information.

Features and/or utilities of the present general inventive concept also provide a computer implemented method of operating a real-time interactive social and business platform, the method includes receiving a plurality of user accounts each having a corresponding profile information and social network on the real-time interactive social and interactive platform, the plurality of user accounts including a first user account, a second user account, and a third user account, receiving work schedule information corresponding to at least one of the first user and the second user, receiving a request for the work schedule information of the second user from the third user account, determining whether the third user account has been accepted within the social network of the second user, and transmitting the work schedule information of the second user to the third user account when the third user account is determined to be accepted within the social network of the second user.

The first user account may correspond to a manager of a business, the second user account corresponds to an employee of the business, and the third user account corresponds to a customer of the business.

The first user profile information may include business identification information and manager identification information. The second user profile information may include second user identification information, employment history information, current work schedule information, customer rating information, and customer comments information.

The third user profile information may include third user identification information.

The social networks of the first, second, and third user accounts may include users approved by the first, second, and third users, respectively.

Additional features and embodiments of the present general inventive concept will be apparent from the following detailed description, drawings, and claims.

### BRIEF DESCRIPTION OF THE FIGURES

The following example embodiments are representative of example techniques and structures designed to carry out the objects of the present general inventive concept, but the present general inventive concept is not limited to these example embodiments. A wide variety of additional embodiments will be more readily understood and appreciated through the following detailed description of the example embodiments, with reference to the accompanying drawings in which:

FIG. 1 is a schematic diagram illustrating an example interactive social media and business platform system according to the present general inventive concept;

FIG. 2 is a flow diagram illustrating an example process for selectively sharing profile information including work schedule information with approved users using the interactive social media and business platform system illustrated in FIG. 1; and

FIGS. 3A-3M illustrates screenshots of an application used to implement the interactive social media and business system according to an exemplary embodiment of the present general inventive concept.

### DETAILED DESCRIPTION OF THE PREFERRED EMBODIMENTS

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the interactive social media and business platform system described herein. Accordingly, various changes, modifications, and equivalents of the system and application used to implement the present general inventive concept described herein may be suggested to those of ordinary skill in the art. Also, description of well-known functions and operations may be simplified and/or omitted for increased clarity and conciseness.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity or operation may be repeated, any activity or operation may be performed by multiple entities or users, and/or any element or feature may be duplicated.

It is noted that the simplified diagrams and drawings included in the present application do not illustrate all the various connections and networks of the various components, however, those skilled in the art will understand how to implement such connections and assemblies, based on the illustrated components, figures, and descriptions provided herein. Numerous variations, modification, and additional embodiments are possible, and, accordingly, all such variations, modifications, and embodiments are to be regarded as being within the spirit and scope of the present general inventive concept.

The interactive social media and business platform system according to the present general inventive concept provides approved users (e.g., guests or customers) with real-time information about businesses and/or employees of the businesses, including current work schedules. The platform records profile information corresponding to the businesses, the staff or employees of the businesses, and the guests or customers of the businesses. The system or platform may then provide approved users with access to the profile information of other users, including current work schedules of the staff, for example.

The platform may receive and store a plurality of profiles and other information corresponding to a plurality of users including a business (e.g., a first user), a staff member of the business (e.g., a second user), and a customer or guest of the business (e.g., a third user).

The interactive social media and business platform system and method according to the present general inventive concept may also provide an all-in-one business (e.g., restaurant) computer executable software application that may act as an interactive social and business platform between businesses, employees or staff of the business, and the guests of the business.

The platform according to the present general inventive concept may further provide businesses with a secure professional communication platform that may be used by the business, their staff, as well as their guests to communicate with each other.

In an example embodiment, the platform may receive and store a first profile information corresponding to a first user (e.g., the business), a second profile information corresponding to a second user (e.g., the staff of the business) and a third profile information corresponding to a third user (e.g., the guests of the business).

The platform may receive and store a plurality of user profiles and other information corresponding to a plurality of users including a business (e.g., a first user), a staff member of the business (e.g., a second user), and a customer or guest of the business (e.g., a third user). However, the present general inventive concept is not limited thereto. That is, in alternative example embodiments, the platform records and manages various other types of user profiles including any user within an organizational hierarchy of employees of the organization. For instance, an owner profile, a manager profile, and a supervisor profile. In alternative embodiments, various members of the business's organization may function as the first user or the second user. For instance, a sales assistant or employee may be inter-changeable as first and second users.

In the present example embodiment, the platform records and manages a first user profile corresponding to the organization, a second user profile corresponding to the employee of the organization, and a third user profile corresponding to a customer of the organization. Each user profiles includes user profile information data and social network data. That is, the user profile information corresponding to each user may include professionally relevant information about the user. In addition, the social network data corresponding to each user may include various other users approved by the user to receive information on the user. For instance, a third user (e.g., a guest) may appreciate the service provided by a second user (e.g., a staff of the business) and may send the third user a social network request in order to be accepted and saved within the second user's social network (i.e., social network data). Once the second user approves the third user's social network request, the profile information corresponding to the third user may then be stored within the second user's social network data. As such, the platform according the present general inventive concept provides the third user access to the user profile information including the work schedule information of all second users who have accepted and approved the third user's social network request. The third user 30 may also then save his or her favorite second users 20 (e.g., staff or employees) and easily view whether his or her favorite second users 20 who are currently working at their place of employment, in real-time.

In an example embodiment, the platform according to the present general inventive concept may output a first indicator (e.g., visual green light) on a display device corresponding to the third user 30 when second users 20 who have approved the third user's social network request are currently working at their place of employment (i.e., first user or business). However, the present general inventive concept is not limited thereto. That is, in alternative exemplary embodiments, the system and method may provide a seamless platform which integrates and/or synchronizes with various other business management programs including ERM, CRM, and social networks.

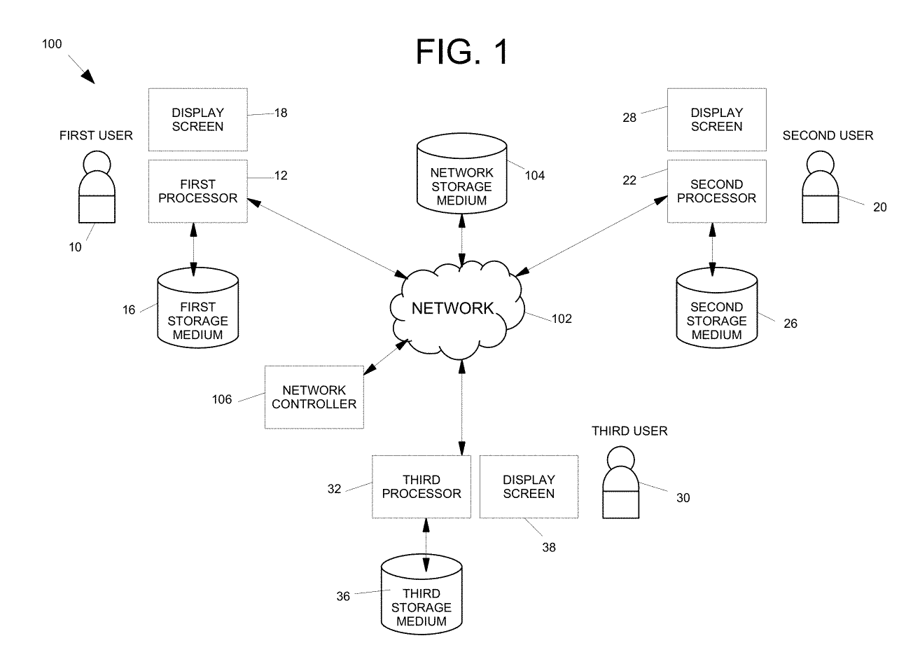

FIG. 1 is a schematic diagram illustrating an example interactive social media and business platform system 100 according to the present general inventive concept. In the present example embodiment, a plurality of users (e.g., a first user 10, a second user 20, and a third user 30) may download software or an application executable on a processor (e.g., a first processor 12, a second processor 22, and a third processor 32) from a network 102 to operate the interactive social media and business platform 100. The network 102 may be connected to or in communication with a network storage medium 104 which may store information or data received from the plurality of users, and a network controller 106 used to control functions of the social media and business platform 100. Each processor may also be connected to a display screen (e.g., a first display screen 18, a second display screen 28, and a third display screen 38) on which the network controller 106 and/or the processors may be used to display various information, indicators, and/or other data. The processors 12, 22, and 32 may include various types of processors and may comprise various hand-held devices, networked personal computers, main frame computers, mobile phones, tablets, or the like. However, the present general inventive concept is not limited thereto.

In alternative example embodiments, the users may execute software or applications stored on storage mediums (e.g., a first storage medium 16, a second storage medium 26, and a third storage medium 36) connected to or in communication with the corresponding processors to operate functions of the interactive social media and business platform 100. However, the present general inventive concept is not limited thereto.

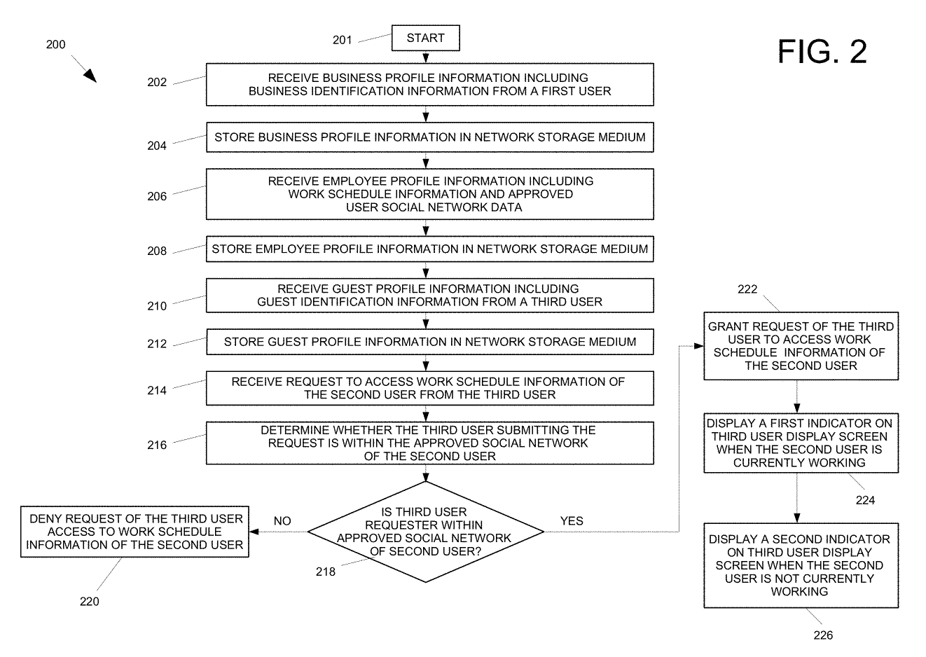

FIG. 2 is a flow diagram illustrating an example method for selectively sharing profile information including work schedule information with approved users using the interactive social media and business platform system 100 illustrated in FIG. 1, according to an exemplary embodiment of the present general inventive concept.

Referring to FIGS. 1 and 2, the plurality of users 10, 20, and 30 may use the interactive social media and business platform system 100 to create, store, and access user profile information corresponding to each user. For instance, the first user 10 may use the first processor 12 to create a first user profile information (e.g., business profile information) corresponding to a business and may send this business profile information to be stored in the network storage medium 104 through the network 102 using the network controller 106. The network controller 106 may receive the first user profile information from the first processor 12 and store the first user profile information in the network storage medium 104.

Similarly, the second user 20 may use the second processor 22 to create a second user profile information (e.g., employee profile information) corresponding to an employee or staff of the business and may send this employee profile information to be stored in the network storage medium 104 through the network 102. The network controller 106 may receive the second user profile information from the second processor 22 and store the second user profile information in the network storage medium 104. In addition, the third user 30 may use the third processor 32 to create a third user profile information (e.g., customer or guest profile information) corresponding to a customer or guest of the business and may send this customer profile information to be stored in the network storage medium 104 through the network 102. The network controller 106 may receive the third user profile information from the third processor 32 and store the third user profile information in the network storage medium 104.

In the present embodiment, the first user profile information (i.e., business profile information) may include profile information such as business identification information, hours of operation, contact information, manager identification information, and the like. The first user profile information may further include a first user social network data including various users that the first user has authorized and/or approved to access and view the first user profile information.

The second user profile information (i.e., employee profile information) may include employee identification information, employment history information, current work schedule information, customer rating information, customer comments information, and the like. The second user profile information may further include a second user social network data including various users that the second user has authorized and/or approved to access and view the second user profile information. Similarly, the third user profile information (i.e., customer or guest profile information) includes customer identification information and the like. The third user profile information may further include a third user social network data including various users that the third user has authorized and/or approved to view the third user profile information.

In the present embodiment, the method 200 for selectively sharing profile information including work schedule information with approved users using the interactive social media and business platform system 100 begins at step 201.

In the present example embodiment, the network controller 106 receives user profile information from a plurality of users through the network 102 and stores this information within the network storage medium 104. At step 202, the interactive social media and business platform system 100 receives business profile information from the first user 10. At step 204, the system 100 may use the network controller 106 to store the received business profile information from the first user 10 in the network storage medium 104. At step 206, the system 100 may receive employee profile information, which includes work schedule information and users approved by the second user 20 to access and view the employee profile information. At step 208, the system 100 may use the network controller 106 to store the received employee profile information from the second user 20 in the network storage medium 104.

At step 210, the system 100 may receive guest profile information which includes guest identification information and users approved by the third user 30 to access and view the guest profile information. At step 212, the system 100 may use the network controller 106 to store the received guest profile information from the third user 30 in the network storage medium 104. The interactive social media and business platform system 100 may then receive a request to access profile information of the second user 20 (i.e., the employee) from the third user 30 (i.e., the guest), at step 214. The request to access the second user's profile information, including the second user's current work schedule information may be generated by the third processor 32 corresponding to the third user 30 and then may be transmitted to and received by the network controller 106 and then stored in the network storage medium 104 through the network 102.

In an example embodiment, the network controller 106 of the interactive social media and business platform system 100 may then send a notification to the second processor 22 corresponding to the second user 20. This notification may be generated by the network controller 106 and displayed on the display screen 28 as an alert message notifying the second user 20 that the third user 30 is requesting access to view the second user's profile information.

At step 216, the network controller 106 may then determine whether the identification information corresponding to the third user 30 who submitted the request to access the second user's profile information is stored within the second user's social network data. In alternative exemplary embodiments, the network controller 106 may automatically determine whether the third user 30 is approved by the second user 20 and may then provide access to the second user's profile information including work schedule information to the third user 30.

At step 218, the system 100 may review the user profile information of the third user 30 and the user profile of the second user 20 stored within the network storage medium 104 to determine whether the second user 20 has authorized or approved the third user 30 to be added to the second user social network data. That is, the network controller 106 may automatically compare the identification information of the third user with identification information stored within the second user's social network data. If the network controller 106 determines that the third user 30 requester is within the second user's social network data, the network controller 106 automatically grants access to the second user's profile information and work schedule information to the third user 30.

At step 220, the system 100 may deny the request of the third user 30 to access to the second user's profile information including work schedule information, when the system 100 determines that the third user 30 is not within the authorized or approved social network data of the second user 20.

Conversely, at step 222, when the system 100 determines that the third user 30 is within the authorized or approved social network data of the second user 20, the network controller 106 of the system 100 may then grant or allow the request of the third user 30 to access the second user's profile information, including current work schedule information.

At step 224, the third processor 32 corresponding to the third user 30 may receive a grant access signal generated and transmitted by the network controller 106. The third processor 32 may then generate and display a first indicator (e.g., a green light) on the display screen 38 corresponding to the third user 30 when the network controller 102 determines that the second user 10 is currently working, based on a review of the second user's profile information stored within the network storage medium 104.

At step 226, the third processor 32 may then generate and display a second indicator (e.g., a red light) on the display screen 38 when the network controller 102 determines that second user 20 is not currently working, based on a review of the second user's profile information stored within the network storage medium 104. However, the present general inventive concept is not limited thereto.

In alternative example embodiments, the interactive social media and business platform 100 according to the present general inventive concept may generate an audio and/or visual indicator to alert the authorized third users 30 within the second user's social network data when the second user 20 is currently working (i.e., on duty). The system or platform 100 generates and displays a first visual indicator (e.g., a green light) on the display screen of the third user's communication device (e.g., mobile device) when the platform 100 determines that the third user 30 has been previously approved to the second user's social network data by the second user 10 and that the current work schedule information within the second user's profile indicates that the second user is currently working at the business or organization defined within the second user's employment history information.

In use, a guest named Bill (e.g., a third user), for example, may visit a business or restaurant and may wish follow a particular employee Sarah (e.g., a second user) of the business of a first user (e.g., Acme Inc.). Bill may then use the third processor 32 to send a social network request to be added to Sarah's social network data. Sarah may then accept or decline the social network request of Bill requesting to be added to her social network data. If accepted by Sarah, Bill may then access Sarah's user profile information including current work schedule information. That is, the second user's (i.e., Sarah's) profile information, including employee identification information, employment history information, current work schedule information, customer rating information, and customer comments information may be visible on the display device corresponding to Bill.

In an example embodiment, first users (i.e., managers of Acme Inc.), second users (i.e., employees of Acme Inc.), and third users (i.e., customers of Acme Inc.) may each install the mobile application according to the present invention onto his or her communication device. Through the application, the first users (e.g., corporation or business), the second users (e.g., employees of the business), and third users (e.g., customers or guests of the business) may input user profile information which may then be stored within a network storage medium 104. The system 100, method 200, and mobile application according to the present invention may be configured for various industries including but not limited to the retail industry, the hospitality industry, the fashion industry, the fitness/personal wellness industry, the healthcare/medical industry, as well as various other appointment based professions such as personal trainers, therapists, and hair stylists. However, the present general inventive concept is not limited thereto.

Each user's profile information may include professionally relevant information with respect to the organization, the employee, and the customer. For instance, the first user (i.e., managers of the corporation) profile information may include business identification information, manager identification information, first user social network information, and the like. The second user (i.e., employees of the corporation) profile information may include second user identification information, employment history information, current work schedule information, customer rating information, customer comments information, and second user social network information. The third user (i.e., customers of the organization) profile information may include third user identification information and third user social network information. In addition, each user may have a unique list of accepted social contacts which are stored within the social network information corresponding to each user. Further, each user may control user's who are added to their social network data by accepting or rejecting other user's social network request.

The interactive social media and business platform according to the present general inventive concept utilizes employees user profiles and social networks to attract, maintain, and keep customers of the business.

The interactive social media and business platform may be applied to a plurality of organizations and businesses. For instance, in the restaurant business, the interactive social media and business platform may be used to allow customers to have access to real-time scheduling information of managers, employees, hosts, servers, bartenders, chefs, and others involved in the restaurant. However, the present general inventive concept is not limited thereto.

The interactive social media and business platform system according to an exemplary embodiment of the present general inventive concept may further include a communication network connected to a network storage medium or database, a plurality of wireless electronic communication devices (e.g., a first, second, and third wireless device) corresponding to a plurality of users (e.g., a first, second, and third user). In addition, each of the electronic devices may be in communication with each other through the communication network with the use of the network controller 106.

The interactive social media and business platform system may further include a network controller 106 configured to manage and/or control a transmission of information between the first, second, and third communication devices.

The network storage database connected to the communication network may be configured to store information corresponding to the first user, the second user, and the third user.

In the present exemplary embodiment, the first user corresponds to a manager of a business, the second user corresponds to an employee of the business, and the third user corresponds to a customer of the business. However, the present general inventive concept is not limited thereto. That is, in alternative embodiments, each user may function as other types of users.

The user information may include a first user profile information corresponding to the first user, a second user profile information corresponding to the second user, and a third user profile information corresponding to the third user. However, the present general inventive concept is not limited thereto.

In exemplary embodiments, the first user profile information may include business identification information, manager identification information, and first user social network information. However, the present general inventive concept is not limited thereto.

In exemplary embodiments, the second user profile information may include second user identification information, employment history information, current work schedule information, customer rating information, customer comments information, and second user social network information. However, the present general inventive concept is not limited thereto.

In exemplary embodiments, the third user profile information may include third user identification information and third user social network information. However, the present general inventive concept is not limited thereto.

In the present exemplary embodiment, the third user may send a social network request signal to the second user to request to be added to the social network information of the second user through the network controller 106. The third user may then be added to the social network information of the second user when the social network request of the third user 30 is approved and/or accepted by the second user 20.

Similarly, the third user may send a social network request to the first user to be added to the social network information of the first user, and may access user profile information corresponding to the first user when the social network request of the third user is accepted by the first user.

The network controller 106 may be configured to automatically update the current work schedule of the second user 20 when instructed to do so by the first user 10. In alternative embodiments, the network controller 106 may be configured to transmit the current work schedule information of the second user 20 to all third users 30 added to the second user's social network information by the second user 10.

The network controller 106 may further be configured to transmit the first user profile information of the first user 10 to third user's added to the first user's social network information by the first user. In exemplary embodiments, the network controller 106 may allow the first user 10 to view and regulate communications transmitted between the second user 20 and the third user 30.

The interactive social media and business platform system according to another exemplary embodiment of the present general inventive concept may include a mobile device (i.e., a communication device) having a display screen to display an interactive menu screen to allow a first user to input and receive user profile information. The mobile device may include at least one processor to generate the interactive menu screen displayed on the display screen, a memory device coupled to the at least one processor and configured to store program instructions that when instructed by the first user operate functions of the interactive social media and business platform system according to the present general inventive concept.

In the present exemplary embodiment, the first user 10 may execute the program instructions according to the present general inventive concept stored on the memory device to cause the processor perform a plurality of functions including displaying the interactive menu screen on the display screen, receiving first user profile information corresponding to the first user, transmitting the first user profile information to a network controller to be stored within an internal or external database or storage medium, transmitting a request to retrieve second user profile information corresponding to a second user stored within the internal or external storage medium through the network, wherein the second user profile information may include second user employment location information and work schedule information. However, the present general inventive concept is not limited thereto. That is, in alternative exemplary embodiments, the program providing the instructions according to the present general inventive concept my be stored and executed from a single processor having sufficient memory to store and execute the functions of the present general inventive concept. In alternative exemplary embodiments, the first user may execute the program instructions stored on the memory device to cause the processor to receive the second user profile information from the external database if the first user is stored within a second user's social network stored within the external database and to display a first visual indicator on the interactive menu screen corresponding to the first user when the second user is scheduled to work on a date input by the first user and/or a second visual indicator when the second user is off duty on the inputted date.

In exemplary embodiments, the first visual indicator may be displayed as a green colored image on the display screen. In alternative embodiments, a second visual indicator may be displayed as a red colored image on the display screen. However, the present general inventive concept is not limited thereto. That is, in an exemplary embodiment only a first visual indicator may be displayed notifying third users that the second user is currently on duty.

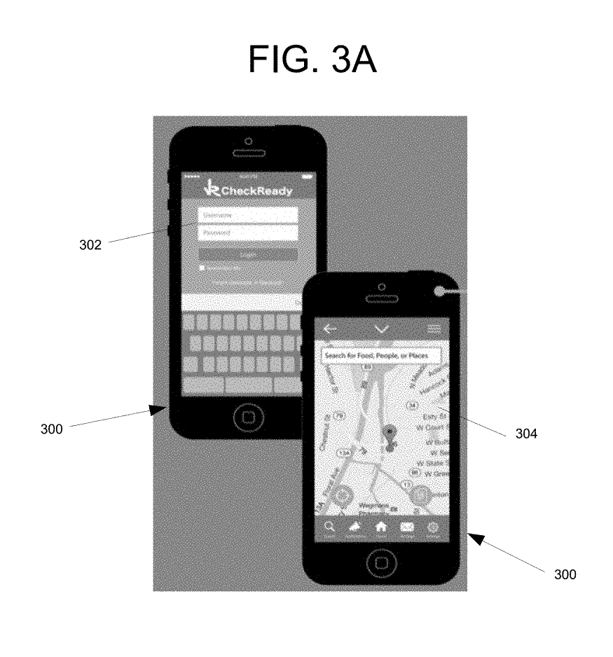

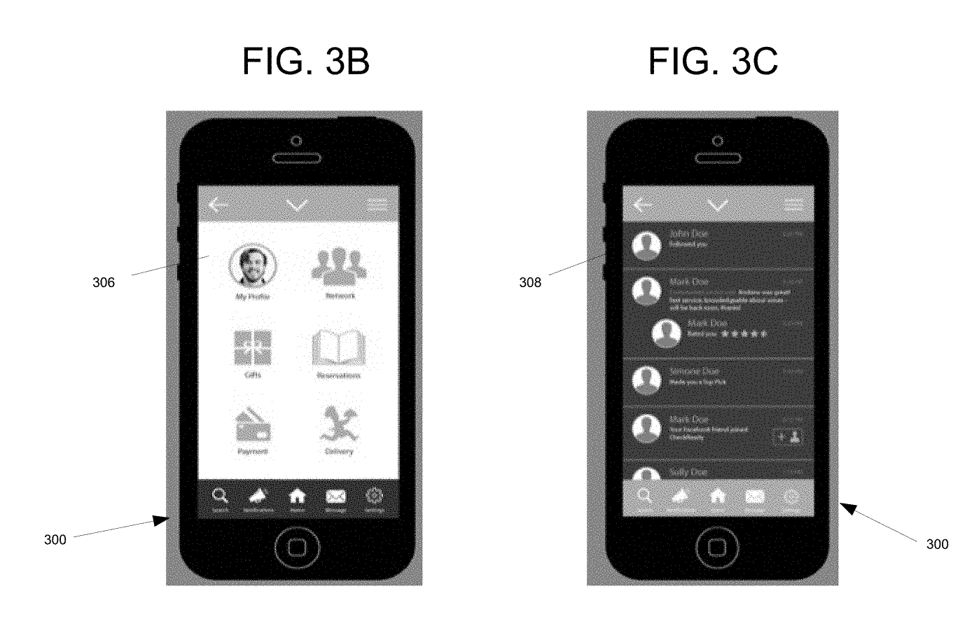

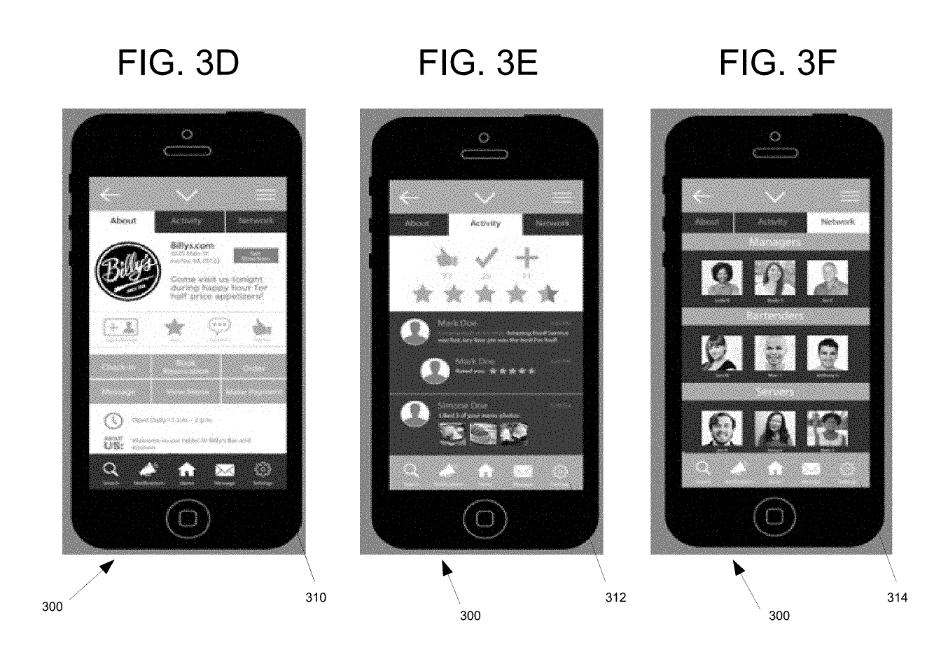

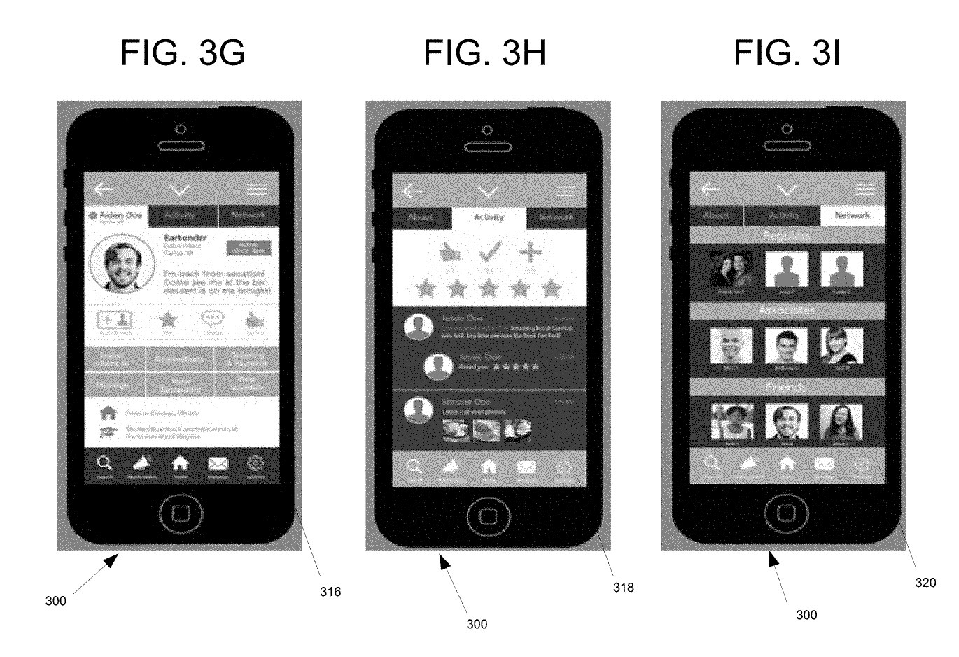

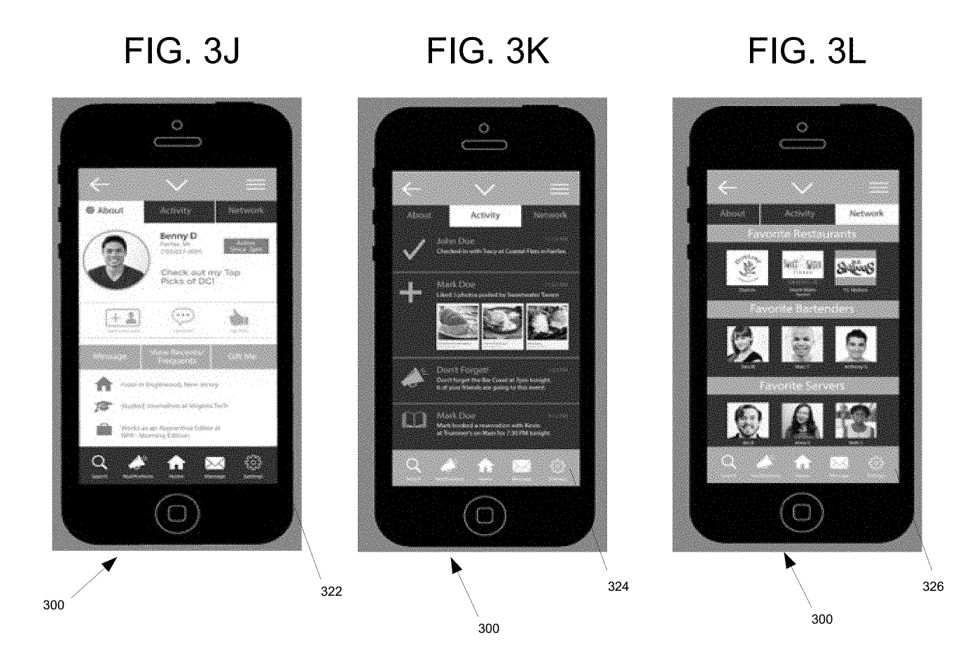

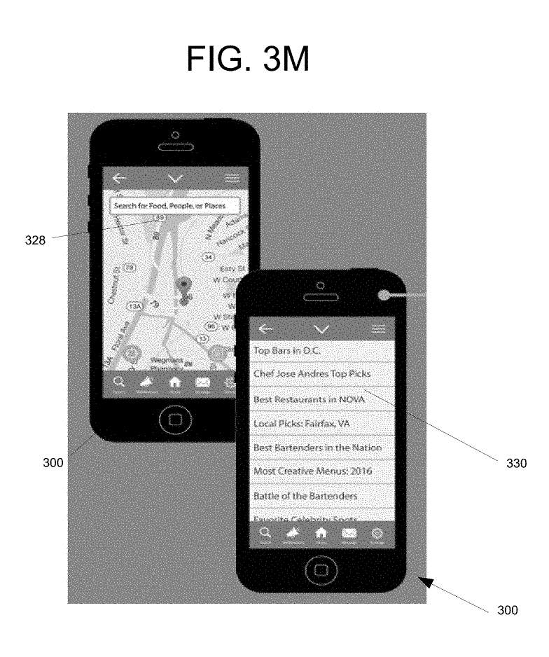

FIGS. 3A-3M illustrates screenshots of an application used to implement the interactive social media and business system 100 according to an exemplary embodiment of the present general inventive concept.

FIG. 3A illustrates a login screen 302 displayed on a communication device 300 in which a user may use to login into the application used to implement the interactive social media and business system 100. FIG. 3A further illustrates a location of a second user on a map view screen 304 displayed on a third user's communication device 300.

FIG. 3B is a main menu screen 306 displayed on the communication device 300 which illustrates various functions of the interactive social media and business system 100. FIG. 3C is a user activity screen 308 displayed on the communication device 300 which illustrates activity history of users of the interactive social media and business system 100. Activity includes, but is not limited to, adding users to a social network, messaging, commenting, rating, check-ins, reservations, photos, and the like.

FIG. 3D is a user profile screen 310 (i.e., a first user 10) displayed on the communication device 300 which illustrates the first user's profile information (e.g., business).

FIG. 3E is a first user comment/rating screen 312 displayed on the communication device 300 of the interactive social media and business system 100.

FIG. 3F is a social network screen 314 of the first user displayed on the communication device 300 corresponding to the first user 10 which illustrates users approved to the first user's social network data within the interactive social media and business system 100.

FIG. 3G is a second user profile screen 316 (i.e., a second user 20) displayed on the communication device 300 which illustrates a second user's profile information (e.g., bartender).

FIG. 3H is a second user 20 comment/rating screen 318 displayed on the communication device 300 of the interactive social media and business system 100.

FIG. 3I is a social network screen 320 of the second user 20 displayed on the communication device 300 corresponding to the second user 20 which illustrates users approved to the second user's social network data within the interactive social media and business system 100.

FIG. 3J is a user profile screen 322 (i.e., a third user 30) displayed on the communication device 300 which illustrates a third user's profile information (e.g., guest).

FIG. 3K is a third user 30 comment/rating screen 324 displayed on the communication device 300 of the interactive social media and business system 100.

FIG. 3L is a social network screen 326 of the third user 30 displayed on the communication device 300 corresponding to the second user 30 which illustrates users approved to the third user's social network data within the interactive social media and business system 100.

FIG. 3M is a search screen 328 of approved users which may be used by third users (e.g. guests) to determine which users within their approved social network are currently working and where, which may be performed by the system 100 in real time. The search screen 328 may display location and work schedule information of second users 20 to third users 30, in real-time. In alternative exemplary embodiments, the search screen 328 may display an individual second user 20 currently working as an image or icon overlaid on a map.

FIG. 3M further illustrates curated guides/lists generated from user preferences and ratings 330 displayed on a third user's communication device 300.

The platform and system according to the present general inventive concept may output and display a visual indicator on a display device corresponding to a third user when second users within the third user's social network are currently working.

The platform and system according to the present general inventive concept further allows business's to monitor, manage, and control communication between employee's (i.e., second users) and guests (i.e., third users).

The platform and system according to the present general inventive concept further allows employees (i.e., second users) to provide incentives and discounts to maintain a following of guests to increase revenue for businesses.

The platform and system according to the present general inventive concept further provides a seamless platform which integrates and/or synchronizes with various other business management programs including ERM, CRM, and social networks.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. An interactive social and business platform system comprising:
a first communication device coupled to a first processor, a first display screen, and a first storage medium;
a second communication device coupled to a second processor, a second display screen, and a second storage medium;
a third communication device coupled to a third processor, a third storage medium, and a third display screen;
a network storage medium to store a first user profile information corresponding to the first communication device, a second user profile information corresponding to the second communication device, and a third user profile information corresponding the third communication device, the network storage medium in communication with the first, second, and third communication device through a communication network; and
a network controller configured to control access to user profile information stored within the network storage medium based upon user profile information corresponding to a communication device requesting access.

2. The system of claim 1, wherein the first communication device corresponds to a business, the second communication device corresponds to an employee of the business, and the third communication device corresponds to a guest of the business.

3. The system of claim 2, wherein the first user profile information includes business identification information, manager identification information, and a first user social network information.

4. The system of claim 2, wherein the second user profile information includes second user identification information, employment history information, current work schedule information, guest rating information, guest comments information, and second user social network information.

5. The system of claim 4, wherein the third user profile information includes third user identification information and third user social network information.

6. The system of claim 5, wherein the network controller adds the third user identification information to the second user social network information when the second communication device sends an approve signal authorizing the third communication device.

7. The system of claim 6, wherein the network controller provides access to the second user profile information to the third communication device when the network controller determines that the third user identification information corresponding to the third communication device is within the second user social network information stored within the network storage medium.

8. The system of claim 7, wherein the network controller automatically updates the current work schedule of a second user corresponding to the second communication device when receiving an update signal from the first communication device.

9. The system of claim 8, wherein the network controller instructs the third processor to generate and display a first indicator on the third display screen when the network controller determines that the second user is currently working based on the second user profile information stored within the network storage medium.

10. The system of claim 1, wherein the network controller allows the first, second, and third communication devices to communicate with each other through the communication network.

11. The system of claim 1, wherein the network controller allows the first communication device to monitor communications between the second and third communication devices.

12. A communication device having a display screen to display an interactive menu screen to allow a first user to input and receive information, the device comprising:
at least one processor to generate the interactive menu screen displayed on the display screen;
a memory device coupled to the at least one processor and configured to store program instructions that when instructed by the first user causes the at least one processor to:
display the interactive menu screen on the display screen;
receive first user profile information corresponding to the first user;
transmit the first user profile information to a network controller to be stored within an external storage medium;
transmit a request signal to the network controller to retrieve second user profile information corresponding to a second user stored within the external storage medium through the network, the second user profile information including second user identification information, employment history information, current work schedule information, guest rating information, guest comments information, and second user social network information;
receive the second user profile information from the external storage medium when the network controller determines that the first user is stored within the second user social network information; and
display a first visual indicator on the interactive menu screen when the second user is scheduled to work on a date input by the first user.

13. The communication device of claim 12, wherein the first visual indicator is a green colored image displayed on the display screen.

14. A computer implemented method of operating a real-time interactive social and business platform, the method comprising:
receiving a plurality of user profile information corresponding to a plurality of communication devices, the plurality of user profile information including a first user profile information, a second user profile information, and a third user profile information;
storing the plurality of user profile information in a network storage medium using a network controller, the first user profile information corresponding to a first user communication device, the second user profile information corresponding to a second user communication device, and the third user profile information corresponding to a third user communication device;
receiving a request signal by the network controller from the third user communication device to retrieve user profile information corresponding to the second user communication device; and
transmitting the second user profile information to the third user communication device when the network controller determines that the third user profile information is stored as an approved user within the second user profile information.

15. The computer implemented method of claim 14, wherein the first user profile information includes business identification information and manager identification information.

16. The computer implemented method of claim 14, wherein the second user profile information includes second user identification information, employment history information, current work schedule information, customer rating information, and customer comments information.

17. The computer implemented method of claim 16, further comprising displaying a first indicator on the third user communication device when the network controller determines that a second user corresponding to the second user communication device is currently working based on the second user profile information.

18. The computer implemented method of claim 17, further comprising displaying a location of where the second user is currently working based on the current work schedule information within the second user profile information.

19. The computer implemented method of claim 17, further comprising displaying a second indicator on the third user communication device when the network controller determines that the second user corresponding to the second user communication device is currently off duty based on the second user profile information.

20. The communication device of claim 17, wherein the first visual indicator is a green colored image displayed on the third communication device in real-time.
